(19) United States
(12) Patent Application Publication
(10) Pub. No.: US 2009/0034634 A1
(43) Pub. Date: Feb. 5, 2009

(54) DIFFERENTIAL CODING WITH LOSSY EMBEDDED COMPRESSION

(75) Inventor: Renatus Josephus Van Der Vleuten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/281,006

(22) PCT Filed: Feb. 23, 2007
(86) PCT No.: PCT/IB07/50577

§ 371 Date: Aug. 28, 2008

(30) Foreign Application Priority Data
Mar. 3, 2006 (EP) 06110624.1

(51) Int. Cl. H04B 1/66

(52) U.S. Cl. 375/241; 375/240.12

(57) ABSTRACT

A coding system (1) comprises an encoder device (2) and a decoder device (3) which both have a memory unit (23; 33) arranged in a loop for generating a prediction signal (y; g). The memory units apply lossy compression to reduce the memory requirements. In order to prevent drift due to dissimilar data reduction, the lossy compression in the encoder device (2) is substantially identical to the lossy compression in the decoder device (3). For example, both compressions may involve identical algorithms, compression factors and/or compression parameters.

The present invention relates to differential coding. More in particular, the present invention relates to a system for encoding and decoding data, such as video images or speech frames, utilizing the difference between present data and past data.

Differential coding is well known, and is widely used in the field of video or image coding. An image may be represented by a set of digital values, each value representing the brightness of a pixel (picture element) or, if color is used, the brightness of a constituent color of a pixel. In order to transmit and/or store images efficiently, these pixel values are encoded. An efficient encoding can often be achieved when the magnitude of the pixel values is reduced, in particular when the magnitude of some values is reduced to zero.

The pixel values can effectively be reduced by producing a prediction of the image on the basis of a previous image, encoding only the difference between the actual image and the predicted image. Obviously, if the image has not changed, the differential image can be represented by zeroes only and can be encoded extremely efficiently. However, the storage of the predicted image (or of a previous image from which a predicted image is derived) may require a large memory, in particular when the image is a high-resolution color image. To reduce the memory requirements, the predicted image may be compressed prior to storage (“embedded compression”).

Lossless compression, which allows a full reconstruction of the compressed image without any loss of information, may not provide sufficient compression to reduce the memory requirements in a satisfactory manner. For this reason, lossy compression is often used prior to storing the predicted image.

However, lossy compression does not allow a full reconstruction of the compressed image and the decompressed predicted image will not provide an optimum prediction of the actual image. In addition, memories for storing predicted images are typically arranged in a prediction loop, each predicted image being used for determining the next predicted image. Discrepancies between the original (uncompressed) predicted image and the decompressed predicted image may therefore compound in the prediction loop, which leads to less efficient coding.

A further problem is caused by the fact that embedded compression may be used in the encoder only, not in the decoder. As the discrepancies in the prediction loop of the encoder accumulate, a coding error is introduced which is not compensated in the decoder. As a result of this so-called “drift”, the image quality will deteriorate. A similar drift occurs if embedded compression is used in the decoder only. The Prior Art fails to provide a satisfactory solution for this problem.

The well-known MPEG standards (MPEG=Moving Picture Experts Group, see http://www.chiariglione.org/mpeg/) define video decoding devices. Drift problems may occur if encoding devices use embedded memory compression while the corresponding decoder devices fail to compensate any resulting drift.

International Patent Application WO 03/039158 (Philips) discloses a method of controlling decoder drift caused by memory compression. The difference between the uncompressed and the decompressed image is determined during a first pass of the coding loop, and this difference is compensated during a second pass. However, if the drift changes between the first and the second pass, some discrepancy will remain. In addition, this known method has the disadvantage of requiring a large amount of memory, which contradicts the reason for compressing images prior to storage. The entire contents of WO 03/039158 are herewith incorporated in this document.

It is an object of the present invention to overcome these and other problems of the Prior Art and to provide a method and system for coding with embedded compression in which any drift is substantially eliminated.

Accordingly, the present invention provides an encoder device comprising:

a subtraction unit for subtracting an encoder prediction signal from an input signal so as to produce a difference signal,

an encoding unit for encoding the difference signal so as to produce an encoded signal,

an addition unit for adding the difference signal and the encoder prediction signal so as to produce a combined signal, and a memory unit for temporarily storing the combined signal so as to produce the prediction signal, the memory unit being arranged for lossy compression and decompression of the combined signal,

which encoder device is arranged for adding to the encoded signal information indicative of the lossy compression and/or decompression.

By providing an encoder device capable of providing information regarding the lossy compression and/or decompression used, it becomes possible for a decoder device to utilize this information and to apply effectively the same lossy compression and/or decompression. In this way, actual identity or functional identity of the encoder and decoder embedded compression processes can be achieved, and drift is avoided.

In a first embodiment, the information indicative of the lossy compression and/or decompression is contained in an encoding setting, such as an encoding profile or level. In a second embodiment, the information indicative of the lossy compression and/or decompression is contained in parameters, and the encoder device further comprises a multiplexer for multiplexing the encoded signal and said parameters. In a third embodiment, the information indicative of the lossy compression and/or decompression is communicated between the encoder device and the decoder device separately, for example using dedicated signals in an embedded compression synchronization protocol prior to the actual transmission of encoded data.

The present invention also provides a decoder device comprising:

a decoding unit for decoding the encoded signal so as to produce a decoded signal,

an addition unit for adding the decoded signal and a decoder prediction signal to produce an output signal, and

a memory unit for temporarily storing the output signal so as to produce the decoder prediction signal, the memory unit being arranged for lossy compression and decompression of the decoder prediction signal,

which decoder device is arranged for receiving and interpreting information indicative of the lossy compression and/or decompression.

Additionally, the present invention provides a coding system comprising an encoder device and a decoder device, the encoder device comprising:

a subtraction unit for subtracting an encoder prediction signal from an input signal so as to produce a difference signal, an encoding unit for encoding the difference signal so as to produce an encoded signal,

an addition unit for adding the difference signal and the encoder prediction signal so as to produce a combined signal, and

a memory unit for temporarily storing the combined signal so as to produce the prediction signal, the memory unit being arranged for lossy compression and decompression of the combined signal, the decoder device comprising:
a decoding unit for decoding the encoded signal so as to produce a decoded signal,
an addition unit for adding the decoded signal and a decoder prediction signal to produce an output signal, and
a memory unit for temporarily storing the output signal so as to produce the decoder prediction signal, the memory unit being arranged for lossy compression and decompression of the decoder prediction signal,
   wherein the encoder memory unit and the decoder memory unit are arranged for producing a substantially identical output signal when presented with the same input signal.

By providing an encoder memory unit and a decoder memory unit which produce substantially identical output signals when presented with identical input signals, it is assured that any drift in the encoder device can be compensated in the decoder device. It is noted that the term “substantially identical” implies completely identical or nearly identical, or at least similar. Complete identity of the memory unit output signals in the case of complete identity of the input signals is preferred, but may not be required in some applications, and similar output signals may be sufficient to reduce any drift to acceptable levels.

It is preferred that the encoder memory unit and the decoder memory unit are arranged for similar, preferably identical compression of the combined signal and the output signal respectively. This allows similar or identical output signals if substantially identical decompression is used, thus substantially or completely eliminating any drift. However, it is possible for the encoder and decoder compression not to be similar, as long as their dissimilarity is compensated by the decompression.

It is noted that Prior Art solutions to the drift problem typically address the decoder device only, leaving the encoder device unaltered. The present invention provides a simple yet very effective solution by effectively “synchronizing” the encoder drift and the decoder drift, thus eliminating its undesired effects. By requiring that the embedded compression of the decoder device is similar, and preferably even identical, to the embedded compression of the encoder device, any encoder drift can be fully compensated in the decoder device.

It is preferred that the compression in the encoder memory unit and the decoder memory unit involves identical algorithms, identical compression factors and/or identical compression parameters. That is, it is preferred that the compression algorithms be identical, although similar algorithms yielding nearly identical results may also be used. Likewise, similar or identical compression factors, and/or similar or identical compression parameters are also preferred. It will be understood that it is most preferred that the encoder embedded compression is fully identical to the decoder embedded compression, but that this complete identity is not required to benefit from the present invention.

Although the encoding device may directly encode the difference signal output by the subtraction unit, further coding efficiency gains may be obtained. The encoder device of the present invention may therefore further comprise a transform unit for transforming the difference signal prior to encoding, and an inverse transform unit for inversely transforming the transformed difference signal prior to adding the difference signal and the encoder prediction signal.

The transform unit may be arranged for performing a Discrete Cosine Transform (DCT), a Fast Fourier Transform (FFT) or another suitable transform. The inverse transform unit serves to reconstitute the untransformed image before producing the prediction image. Similarly, the encoder device may further comprise a quantization unit for quantizing the transformed difference signal prior to encoding, and preferably also an inverse quantization unit for inversely quantizing the quantized difference signal prior to inversely transforming. Further signal processing units may be provided in the encoder device and/or the decoder device, for example motion compensation units (in the case of video coding) or filter units (in the case of audio coding).

If the encoder device comprises a transform unit, it is preferred that the decoder device comprises an inverse transform unit for inversely transforming the decoded signal prior to adding.

In the coding system of the present invention, the encoder device may advantageously be arranged for inserting a marker in the encoded signal indicative of the lossy compression and decompression used in the memory unit. The decoder device may be arranged for interpreting the marker so as to suitably adapt the lossy compression and decompression in the decoder device. The marker may include compression parameters, or may consist of a single bit indicating that lossy embedded compression is used.

The coding system of the present invention may further comprise a medium coupled between the encoder device and the decoder device, the medium preferably being a storage medium or a transmission medium. The storage medium may for example be constituted by electronic memory circuits (e.g. RAM) or a hard disc, while the transmission medium may be constituted by a wireless or wired communication network. Due to the presence of the medium, the encoding and decoding may be separated by space and/or time.

Furthermore, the present invention provides an encoding device for use in the system defined above, as well as a decoding device for use in the system defined above. The encoding device and the decoding device are constituent parts of the system of the present invention. It is noted that the system may be commercialized as a set of parts, the encoding device and the decoding device constituting such parts.

The present invention also provides a consumer device comprising the encoding system as defined above, and a transmission system comprising the coding system as defined above. The consumer device may be constituted by a set-top box, a mobile telephone apparatus, or a video recorder such as a hard-disc recorder or a DVD recorder, and may be arranged for video coding, audio coding and/or speech coding. In the transmission system, the encoder device and the decoder device are preferably arranged at separate locations, for example in different rooms, buildings, towns or even countries. The transmission system according to the present invention may involve television transmission apparatus and/or telecommunication networks, including the Internet (video and/or audio transmission).

The present invention also provides an encoding method comprising the steps of:

subtracting an encoder prediction signal from an input signal so as to produce a difference signal,

encoding the difference signal so as to produce an encoded signal,

adding the difference signal and the encoder prediction signal so as to produce a combined signal, and

temporarily storing the combined signal so as to produce the prediction signal, said step of temporarily storing being arranged for lossy compression and decompression of the combined signal,

which encoding method comprises the additional step of adding to the encoded signal information indicative of the lossy compression and/or decompression.

The present invention further provides a decoding method comprising the steps of:

decoding the encoded signal so as to produce a decoded signal,

adding the decoded signal and a decoder prediction signal to produce an output signal, and

temporarily storing the output signal so as to produce the decoder prediction signal, said step of temporarily storing being arranged for lossy compression and decompression of the decoder prediction signal,

which decoding method further comprises the steps of receiving and interpreting information indicative of the lossy compression and/or decompression.

The information indicative of the lossy compression and/or decompression is preferably comprised in the encoded signal. Additionally, or alternatively, at least part of this information may be received prior to receiving the encoded signal.

The present invention additionally provides a method of coding, the method comprising an encoder stage and a decoder stage, the encoder stage comprising the steps of:

subtracting an encoder prediction signal from an input signal so as to produce a difference signal,

encoding the difference signal so as to produce an encoded signal, adding the difference signal and the encoder prediction signal so as to produce a combined signal, and

temporarily storing the combined signal so as to produce the prediction signal while applying lossy compression and decompression of the combined signal,

the decoder stage comprising the steps of:
decoding the encoded signal so as to produce a decoded signal,
adding the decoded signal and a decoder prediction signal to produce an output signal, and

temporarily storing the output signal so as to produce the decoder prediction signal while applying lossy compression and decompression of the decoder prediction signal, wherein the encoder storing step and the decoder storing step produce a substantially identical output signal when presented with the same input signal.

Advantageously, the encoder storing step and the decoder storing step may involve similar or identical compression of the combined signal and the output signal respectively.

The compression in the encoder storing step and the decoder storing step preferably involves identical algorithms, identical compression factors and/or identical compression parameters. Further preferred embodiments of the inventive method will become apparent from the description below.

The present invention still further provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

The present invention yet further provides an encoded signal containing information indicative of the lossy compression and/or decompression used to produce the signal.

The present invention will further be explained below with reference to exemplary embodiments illustrated in the accompanying drawings, in which:

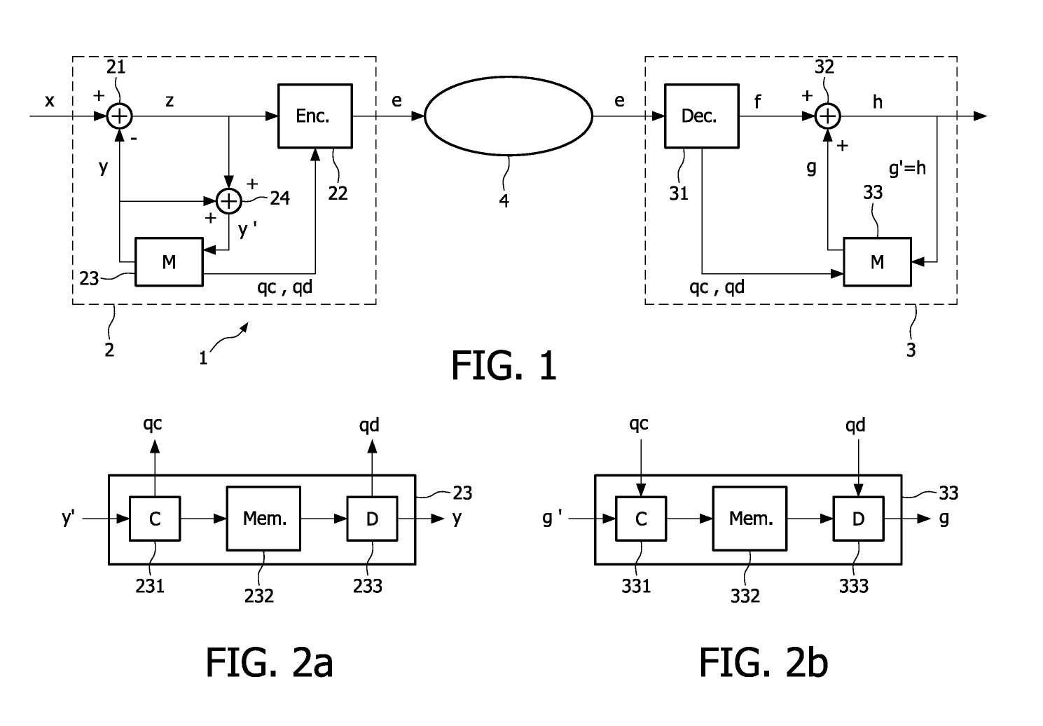

FIG. 1 schematically shows a coding system according to the present invention.

FIGS. 2a and 2b schematically show embedded memory units according to the present invention.

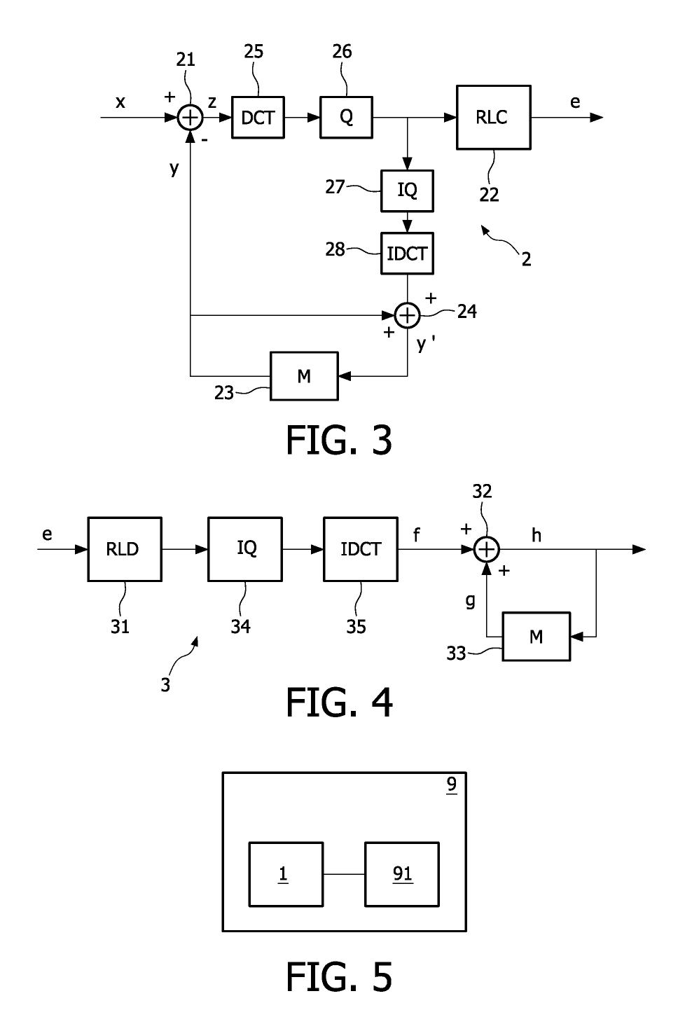

FIG. 3 schematically shows an alternative embodiment of an encoder device according to the present invention.

FIG. 4 schematically shows an alternative embodiment of a decoder device according to the present invention.

FIG. 5 schematically shows a consumer device incorporating a coding system according to the present invention.

The coding system 1 shown merely by way of non-limiting example in FIG. 1 comprises an encoder device 2 and a decoder device 3, coupled by a medium 4. The medium 4 may be any medium suitable for transferring an encoded signal e from the encoder device 2 to the decoder device 3 and may, for example, be constituted by a storage medium (e.g. a hard disc) providing and/or a transmission medium (e.g. a cable network, a radio link and/or the Internet). The transfer of the encoded signal e may therefore be a transfer in time (storage) and/or in place (location). The actual properties of the medium 4 are not essential to the present invention.

The exemplary encoder 2 shown in FIG. 1 has a conventional structure and comprises a subtraction unit 21, an encoder unit 22, a memory unit 23 and an addition unit 24. However, in contrast to the Prior Art, the memory unit 23 has novel properties which will be explained later in more detail. In addition, between the memory unit 23 and the encoder unit 22 an optional connection may be present, the function of which will be explained later.

The subtraction unit 21 receives an input signal x. In the following description, it will be assumed that the signal x is a video signal, but the invention is not so limited and the signal x may also be an audio signal or a speech signal.

Accordingly, in the present non-limiting example the input signal x represents an image. As explained above, the signal x may comprise a set of digital pixel values, each values representing the brightness of a pixel of the image. The signal x may represent a plurality of images and may therefore be written as x[i], where i=1, 2, 3, . . . N, each x[i] representing an image of a total of N images. However, the signal will be denoted x instead of x[i] for convenience.

The subtraction unit 21 subtracts a prediction signal y from the input signal x to produce a difference signal z. This difference signal z is fed to both an encoder 22 and an addition unit 24. The encoder 22 encodes the difference signal z to produce an encoded video output signal e which is fed to the medium 4. The type of encoding used by the encoder 22 may be run length coding, variable length coding or any other suitable form of encoding (compression) that reduces the amount of data of the video signal.

The addition unit 24 adds the current prediction signal y and the difference signal z to produce the future prediction signal y′. Mathematically this may be expressed as follows: if y=y[i], then y′=y[i+1]. This requires the signal y′ to be temporarily stored until the next image (signal x[i+1]) is available. This temporary storage is provided by the memory unit 23. This memory unit 23 and its novel features will later be explained in more detail with reference to FIG. 2.

The decoder device 3 receives the encoded video signal e from the medium 4. The exemplary decoder device 3 of FIG. 1 comprises a decoder unit 31, an addition unit 32 and a memory unit 33. The decoder unit 31 is arranged for performing a decoding which is the inverse of the encoding performed by the encoder 22. The thus decoded (or decompressed) signal f is added to a prediction signal g in the addition unit 32. The resulting output signal h is also fed to the memory unit 33 and serves as the future prediction signal g′. Expressed mathematically: h[i]=g′[i]=g[i+1].

It can thus be seen that both the encoder device 2 and the decoder device 3 comprise a loop containing a memory 23, 33 for producing a prediction signal y, g. As the prediction signals y and g should have as many pixel values as the signals x and f they predict, the temporary storage of this signal typically requires a large amount of memory. To reduce the memory requirements, compression of the prediction signal is used. This so-called embedded compression (which is embedded in the prediction loop) is lossy (that is, involves data loss), as lossless compression typically fails to achieve the desired data reduction. An exemplary structure of the memory units 23 and 33 is illustrated in FIGS. 2a and 2b.

In the embodiment of FIG. 2a, the memory unit 23 is shown to comprise a compression (C) unit 231, a memory 232 and a decompression (D) unit 233. The compression unit 231 compresses the signal y′ using lossy compression, thus reducing the required size of the memory 232. The compressed signal y′ is typically stored until the next image (signal x) is received by the encoder device (2 in FIG. 1). Then the stored signal is decompressed by the decompression unit 233, yielding the signal y. It is noted that the time the signal is stored may vary depending on the particular embodiment. For example, the stored signal may be decompressed just before the next image (signal x) arrives so as to allow for a decompression delay. Alternatively, or additionally, the same signal may be stored while several images are received and encoded, thus using the same prediction signal for two or more images.

Due to the lossy compression and decompression, so-called “drift” may occur: a discrepancy between the actual predicted image and the decompressed predicted image leads to an increase in the difference signal z. This discrepancy is amplified by the prediction loop of which the encoder memory unit 23 is part. This drift is particularly a problem as the decoder memory 33 may also introduce a discrepancy. In Prior Art systems, these discrepancies of the prediction signals are typically unequal and increase over time, thus harming the quality of the decoded video signal.

The present invention solves this problem by ensuring that any drift in the encoder device is at least similar, but preferably equal to the drift in the decoder device. This may accomplished by making the lossy compression in the encoder memory unit 23 at least similar, but preferably equal to the lossy compression in the decoder memory unit 33. In general, the encoder memory unit 23 and the decoder memory unit 33 are arranged in such a way that when presented with identical input signals, their output signals are identical or at least similar. Accordingly, the encoder compression unit 231 and decompression unit 233 taken together result in the same signal processing as the decoder compression unit 231 and decompression unit 233 taken together.

The present invention solves the drift problem without requiring complicated drift compensation measures as disclosed in the Prior Art. Consequently, the encoding system of the present invention can be relatively simple and economical.

The similarity or identity of the lossy embedded compression in the encoder and its counterpart in the decoder can be achieved by choosing one or more of the following features:

identical compression algorithms,

identical compression factors, and

identical compression parameters.

The system of the present invention may be designed as a whole, in which case the embedded compression of the encoder device and the decoder device can be chosen to be identical. If an existing encoder device is used, the decoder device can be designed to match the embedded compression of the encoder device by determining and matching its embedded compression features. However, it is preferred that the encoder device provides information about the embedded compression used and transfers this information to the decoder device. More in particular, it is preferred that the encoder device is arranged for adding to the encoded signal information indicative of the lossy compression and/or decompression, and that the corresponding decoder device is arranged for receiving and interpreting said information.

In order to provide this information, the encoder device 2 of FIG. 1 comprises a connection between the memory unit 23 and the encoder unit 22. This connection serves to feed the information signals qc and qd from the memory unit 23 to the encoder unit 22. Returning to FIG. 2a, it can be seen that the compression unit 231 produces a signal qc indicative of the (embedded) compression used, and that the decompression unit 233 produces a signal qd indicative of the (embedded) decompression used. These embedded compression/decompression information signals qc and qd may include information regarding compression algorithms, compression factors, and/or compression parameters.

The memory unit 23 feeds at least one, but preferably both information signals qc and qd to the encoder unit 22 for encoding into the output signal e. In a preferred embodiment, the information signals qc and qd are used to determine certain encoding settings, such as “profiles” and/or “levels” used in some compression and encoding standards, “profiles” essentially corresponding to application areas and “levels” to decoder complexity. Alternatively, the information signals qc and qd may be determined by the particular “profiles” and “levels” used, in which case the arrows at qc and qd in FIG. 2a would be reversed.

For example, the compression ratio of the compression unit 231 can be determined by a certain “level” within a “profile” indicating embedded compression. Alternatively, or additionally, a multiplexer may be present to multiplex the signals e, qc and qd and to produce a multiplexed output signal (output stream). As a result, the output stream of the encoder device may contain parameters, such as the compression ratio and/or compression quality of the embedded compression. These parameters may be directly placed in the bit stream or be encoded using a suitable type of coding, for example variable length coding. The parameters may also be represented by indicators which may be converted into parameters using a look-up table or a mathematical formula.

It is also possible to communicate the information indicative of the lossy compression and/or decompression between the encoder device and the decoder device separate from the encoded data, for example using dedicated signals in an embedded compression synchronization protocol prior to the actual transmission of encoded data. The encoder device and decoder device could in that case “negotiate” common embedded compression/decompression properties.

The particular embedded compression algorithm used by the encoder may depend upon the application. In video applications, the embedded compression algorithm may involve differential prediction, for example taking into account the previous two pixels on the same line and five pixels on the previous line. The encoder information signals qc and/or qd may be transmitted to the decoder device in a compression signal, for example in MPEG proprietary data. In audio applications, any differential prediction may involve current and/or previous audio samples.

The signal can contain the required information about the used embedded compression in a number of ways (e.g. in proprietary fields). E.g. a video prediction may use a linear prediction of the current pixel on the basis of the previous two pixels on the current line and the 5 on the previous line horizontally symmetric about the pixel position. The signal can then contain the algorithm itself, e.g. software code, or the prediction formula, or parameters, such as e.g. the 7 weight coefficients of the prediction formula. The indication may be as simple as an index number, e.g. if 10 possible algorithms are prescribed in a standard, or have been negotiated (independent of the standard prescriptions) on a previous occasion (e.g. at the start of a communication session, via e.g. a dedicated channel, or prefixed into the sold product during manufacture), the identifying information in the signal may e.g. be “7” indicating that for compressing the present information the 7^{th} of the available compression algorithms was used.

The embedded compression algorithm used could be a hybrid compression algorithm. In that case, motion vectors associated with the embedded compression algorithm could be added to the bit stream. It would be particularly advantageous if the embedded compression algorithm were capable of re-using one or more “building blocks” of the parent compression algorithm employed by the encoder unit 22. This re-use could be accomplished by time-multiplexing (saving integrated circuit surface area) or by duplication (increasing integrated circuit surface area, but saving design effort). In a particular embodiment, this would enable an embedded compression algorithm that simply stores parts of the already compressed parent bitstream and decompresses these parts as needed. This approach would result in relatively high compression ratios and corresponding memory savings, at the expensive of an increase in the (computational) complexity of the decoder.

The data units on which the embedded compression operates could be the same as those of the parent compression (i.e. typically a single slice in video applications), but could also be larger or smaller. Furthermore, certain parameter settings (e.g. quality) could closely correspond to those of the parent compression, but could also be chosen independently.

For example, in an MPEG-2 application, the quality of the embedded compression could be decreased towards the end of a GOP (that is, a Group Of Pictures), since (drift) error propagation will be less severe. This could be used advantageously to increase the available memory (and thus the quality) for the first part of the next GOP. The embedded compression parameters could also depend e.g. on the picture/slice type of the parent compression, with lower quality being used for data that is used only for B-pictures/slices because these pictures are less sensitive to drift.

In the embodiment of FIG. 2b, the decoder memory unit 33 is shown to comprise a compression (C) unit 331, a memory 332 and a decompression (D) unit 333, similar to the encoder memory unit 23 of FIG. 2a. The memory unit 33 receives the signal g′(=h in FIG. 1) and produces the signal g. The decoder memory unit 33 is preferably arranged for receiving information signals qc and qd which are indicative of the embedded compression and decompression respectively. As can be seen in FIG. 1, the decoder unit 31 (or, in an alternative embodiment, a demultiplexer) produces the information signals qc and qd from the input signal e and feeds these information signals to the memory unit 33. As a result, the decoder compression unit 331 is able to use exactly the same (lossy) compression as the encoder compression unit 231, and the decoder decompression unit 333 is able to use exactly the same (lossy) decompression as the encoder decompression unit 233. In this way, compression synchronization is achieved.

A further embodiment of the encoder device 2 of the present invention is illustrated in FIG. 3, where transform and quantization units have been added. A transform unit 25 transforms the difference signal z using a Discrete Cosine Transform (DCT) or another suitable transform. The resulting transform coefficients are quantized in quantization (Q) unit 26 and then fed to both the encoder unit 22 and an inverse quantization (IQ) unit 27. The encoder unit 22 performs Run Length Coding (RLC) or another suitable type of coding to produce the encoded output signal e. The inverse quantization unit 27 produces a de-quantized signal that is fed to a inverse transform unit 28, which performs an Inverse Discrete Cosine Transform (IDCT) or another inverse transform matching the transform carried out by the transform unit 28. The resulting signal is fed to the addition unit 24 to produce the future prediction signal y′, as in the embodiment of FIG. 1.

It is noted that further modifications and additions are possible. For example, motion vectors could be produced to carry out motion compensation and achieve even more efficient coding. Those skilled in the art will be able to modify the encoder devices of FIGS. 1 and 3 accordingly. An optional filter operation may advantageously be incorporated in the decompression unit 233 (FIG. 2).

An alternative embodiment of the decoder device 3 of the present invention is schematically illustrated in FIG. 4. In the exemplary embodiment of FIG. 4, an inverse quantization unit 34 has been added to perform an inverse quantization (IQ), and an inverse transform unit 35 has been added to perform an Inverse Discrete Cosine Transform (IDCT), or any other transform suitable for inverting any transform of the encoder device. Accordingly, the decoder device 3 of FIG. 4 comprises a decoder unit 31 arranged for performing a Run Length Decoding (RLD) or similar decoding operation, an inverse quantization unit 34, an inverse transform unit 35, an addition unit 32 and a memory unit 33. In accordance with the present invention, the decoder memory unit 33 is designed for lossy compression matching the lossy compression of the encoder memory unit 23.

A consumer device according to the present invention is schematically illustrated in FIG. 5. The consumer device 9 comprises a coding system 1 according to the present invention, as well as other elements 91, such as a storage unit. The storage unit may be used for storing coded (compressed) data, such as coded video data, coded audio data and/or coded speech data. The consumer device may be a hard disc recorder, a DVD recorder, a set-top box for pay-TV, a camcorder device, or a mobile telephone apparatus.

In summary, the present invention provides a coding method and system comprising an encoder device and a decoder device which both have a memory unit arranged in a loop for generating a prediction signal. The memory units apply lossy compression to reduce the memory requirements. In order to prevent drift due to dissimilar data reduction, the lossy compression in the encoder device is substantially identical to the lossy compression in the decoder device. For example, both compressions may involve identical algorithms, compression factors and/or compression parameters.

The present invention is based upon the insight that any drift occurring between the encoder prediction loop and the decoder loop can be prevented by ensuring that the lossy compression and decompression in the encoder memory unit has the same effect as the lossy compression and decompression in the decoder memory unit, and that this can be achieved by ensuring that the data reduction involved in both loops is at least similar but preferably identical. The present invention benefits from the further insight that similar or identical data reduction in both the encoder prediction loop and the decoder prediction loop can be achieved by making the data compression involved in those loops similar or identical.

The present invention may be summarized as a coding system comprising an encoder device and a decoder device, both the encoder device and the decoder device comprising a prediction loop including a memory unit, said memory unit being provided with a data compression unit and a data decompression unit, wherein the encoder memory unit and the decoder memory unit are arranged for producing a substantially identical output signal when presented with the same input signal.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. An encoder device (2) comprising:
a subtraction unit (21) for subtracting an encoder prediction signal (y) from an input signal (x) so as to produce a difference signal (z),
an encoding unit (22) for encoding the difference signal (z) so as to produce an encoded signal (e),
an addition unit (24) for adding the difference signal (z) and the encoder prediction signal (y) so as to produce a combined signal (y′), and
a memory unit (23) for temporarily storing the combined signal (y′) so as to produce the prediction signal (y), the memory unit being arranged for lossy compression and decompression of the combined signal (y′),
which encoder device is arranged for adding to the encoded signal (e) information (qc, qd) indicative of the lossy compression and/or decompression.

2. The encoder device according to claim 1, wherein the information (qc, qd) indicative of the lossy compression and/or decompression is contained in an encoding setting, such as an encoding profile or level.

3. The encoder device according to claim 1, wherein the information (qc, qd) indicative of the lossy compression and/or decompression is contained in parameters, and wherein the encoder device further comprises a multiplexer for multiplexing the encoded signal (e) and said parameters.

4. A decoder device (3) comprising:
a decoding unit (31) for decoding the encoded signal (e) so as to produce a decoded signal (f),
an addition unit (32) for adding the decoded signal (f) and a decoder prediction signal (g) to produce an output signal (h), and
a memory unit (33) for temporarily storing the output signal (h) so as to produce the decoder prediction signal (g), the memory unit being arranged for lossy compression and decompression of the decoder prediction signal (g),
which decoder device is arranged for receiving and interpreting information (qc, qd) indicative of the lossy compression and/or decompression.

5. The decoder device according to claim 4, wherein the information (qc, qd) indicative of the lossy compression and/or decompression is contained in parameters, and wherein the decoder device further comprises a demultiplexer for demultiplexing the encoded signal (e) and said parameters.

6. A coding system (1) comprising an encoder device (2) and a decoder device (3), the encoder device comprising:
a subtraction unit (21) for subtracting an encoder prediction signal (y) from an input signal (x) so as to produce a difference signal (z),
an encoding unit (22) for encoding the difference signal (z) so as to produce an encoded signal (e),
an addition unit (24) for adding the difference signal (z) and the encoder prediction signal (y) so as to produce a combined signal (y′), and
a memory unit (23) for temporarily storing the combined signal (y′) so as to produce the prediction signal (y), the memory unit being arranged for lossy compression and decompression of the combined signal (y′),
the decoder device (3) comprising:
a decoding unit (31) for decoding the encoded signal (e) so as to produce a decoded signal (f),
an addition unit (32) for adding the decoded signal (f) and a decoder prediction signal (g) to produce an output signal (h), and
a memory unit (33) for temporarily storing the output signal (h) so as to produce the decoder prediction signal (g), the memory unit being arranged for lossy compression and decompression of the decoder prediction signal (g),
wherein the encoder memory unit (23) and the decoder memory unit (33) are arranged for producing a substantially identical output signal when presented with the same input signal.

7. The coding system according to claim 6, wherein the encoder memory unit (23) and the decoder memory unit (33) are arranged for similar or identical lossy compression and decompression.

8. The coding system according to claim 6, wherein the compression in the encoder memory unit (23) and the decoder memory unit (33) involves identical algorithms, identical compression factors and/or identical compression parameters.

9. The coding system according to claim 6, wherein the encoder device (2) further comprises a transform unit (25) for transforming the difference signal (z) prior to encoding, and an inverse transform unit (28) for inversely transforming the transformed difference signal prior to adding the difference signal (z) and the encoder prediction signal (y).

10. The coding system according to claim 9, wherein the encoder device (2) further comprises a quantization unit (26) for quantizing the transformed difference signal prior to encoding, and preferably also an inverse quantization unit (27) for inversely quantizing the quantized difference signal prior to inversely transforming.

11. The coding system according to claim 9, wherein the decoder device (3) further comprises an inverse transform unit (35) for inversely transforming the decoded signal (f) prior to adding.

12. The coding system according to claim 6, wherein the encoder device (2) is arranged for inserting a marker in the encoded signal (e), said marker being indicative of the lossy compression and decompression used in the encoder memory unit (23).

13. The coding system according to claim 6, further comprising a medium (4) coupled between the encoder device (2) and the decoder device (3), the medium (4) preferably being a storage medium or a transmission medium.

14. A consumer device (9), comprising an encoder device (2) comprising:
a subtraction unit (21) for subtracting an encoder prediction signal (y) from an input signal (x) so as to produce a difference signal (z),
an encoding unit (22) for encoding the difference signal (z) so as to produce an encoded signal (e),
an addition unit (24) for adding the difference signal (z) and the encoder prediction signal (y) so as to produce a combined signal (y′), and
a memory unit (23) for temporarily storing the combined signal (y′) so as to produce the prediction signal (y), the memory unit being arranged for lossy compression and decompression of the combined signal (y′),
which encoder device is arranged for adding to the encoded signal (e) information (qc, qd) indicative of the lossy compression and/or decompression, a decoder device (3) according to claim 4.

15. The consumer device according to claim 14, which is constituted by a set-top box, a mobile telephone apparatus, or a video recorder such as a hard-disc recorder or a DVD recorder.

16. A transmission system, comprising an encoder device (2) comprising:
a subtraction unit (21) for subtracting an encoder prediction signal (y) from an input signal (x) so as to produce a difference signal (z),
an encoding unit (22) for encoding the difference signal (z) so as to produce an encoded signal (e),
an addition unit (24) for adding the difference signal (z) and the encoder prediction signal (y) so as to produce a combined signal (y′), and
a memory unit (23) for temporarily storing the combined signal (y′) so as to produce the prediction signal (y), the memory unit being arranged for lossy compression and decompression of the combined signal (y′),
which encoder device is arranged for adding to the encoded signal (e) information (qc, qd) indicative of the lossy compression and/or decompression, a decoder device (3) according to claim 4.

17. An encoding method comprising the steps of:
subtracting an encoder prediction signal (y) from an input signal (x) so as to produce a difference signal (z),
encoding the difference signal (z) so as to produce an encoded signal (e), adding the difference signal (z) and the encoder prediction signal (y) so as to produce a combined signal (y′), and
temporarily storing the combined signal (y′) so as to produce the prediction signal (y), said step being arranged for lossy compression and decompression of the combined signal (y′), which encoding method is arranged for adding to the encoded signal (e) information (qc, qd) indicative of the lossy compression and/or decompression.

18. A decoding method comprising the steps of:
decoding the encoded signal (e) so as to produce a decoded signal (f),
adding the decoded signal (f) and a decoder prediction signal (g) to produce an output signal (h), and
temporarily storing the output signal (h) so as to produce the decoder prediction signal (g), said step being arranged for lossy compression and decompression of the decoder prediction signal (g),
which decoding method comprises the additional step of receiving and interpreting information (qc, qd) indicative of the lossy compression and/or decompression.

19. The decoding method according to claim 18, wherein the information (qc, qd) indicative of the lossy compression and/or decompression is comprised in the encoded signal (e).

20. The decoding method according to claim 18, wherein at least part of the information (qc, qd) indicative of the lossy compression and/or decompression is received prior to receiving the encoded signal (e).

21. A coding method comprising an encoder stage and a decoder stage, the encoder stage comprising the steps of:
subtracting an encoder prediction signal (y) from an input signal (x) so as to produce a difference signal (z),
encoding the difference signal (z) so as to produce an encoded signal (e),
adding the difference signal (z) and the encoder prediction signal (y) so as to produce a combined signal (y′), and
temporarily storing the combined signal (y′) so as to produce the prediction signal (y) while applying lossy compression and decompression of the combined signal (y′),
the decoder stage comprising the steps of:
decoding the encoded signal (e) so as to produce a decoded signal (f),
adding the decoded signal (f) and a decoder prediction signal (g) to produce an output signal (h), and
temporarily storing the output signal (h) so as to produce the decoder prediction signal (g) while applying lossy compression and decompression of the decoder prediction signal (g), wherein the encoder storing step and the decoder storing step produce a substantially identical output signal when presented with the same input signal.

22. The coding method according to claim 21, wherein the encoder storing step and the decoder storing step involve similar or identical compression of the combined signal (y′) and the output signal (h) respectively.

23. The coding method according to claim 21, wherein the compression in the encoder storing step and the decoder storing step involves identical algorithms, identical compression factors and/or identical compression parameters.

24. The coding method according to claim 21, wherein the encoder stage further comprises a transform step for transforming the difference signal (z) prior to encoding, and an inverse transform step for inversely transforming the transformed difference signal prior to adding the difference signal (z) and the encoder prediction signal (y).

25. The coding method according to claim 24, wherein the encoder stage further comprises a quantization step for quantizing the transformed difference signal prior to encoding, and preferably also an inverse quantization step for inversely quantizing the quantized difference signal prior to inversely transforming.

26. The coding method according to claim 24, wherein the decoder stage further comprises an inverse transform step for inversely transforming the decoded signal (f) prior to adding.

27. The coding method according to claim 21, further comprising an additional stage between the encoder stage and decoder stage, the additional stage preferably being a storage stage or a transmission stage.

28. The coding method according to claim 21, further comprising the step of inserting a marker in the encoded signal (e), said marker being indicative of the lossy compression and decompression used in the encoder storing step.

29. A computer program product for carrying out the encoding method comprising the steps of:
subtracting an encoder prediction signal (y) from an input signal (x) so as to produce a difference signal (z),
encoding the difference signal (z) so as to produce an encoded signal (e),
adding the difference signal (z) and the encoder prediction signal (y) so as to produce a combined signal (y′), and
temporarily storing the combined signal (y′) so as to produce the prediction signal (y), said step being arranged for lossy compression and decompression of the combined signal (y′), which encoding method is arranged for adding to the encoded signal (e) information (qc, qd) indicative of the lossy compression and/or decompression, the decoding method according to claim 18.

30. An encoded signal (e) containing information (qc, qd) indicative of the lossy compression and/or decompression used to produce the signal.
